(19) United States
(12) Patent Application Publication
(10) Pub. No.: US 2019/0208041 A1
(43) Pub. Date: Jul. 4, 2019

(54) SCHEDULING AND GROUPING TRANSMISSION CONTROL PROTOCOL ACKNOWLEDGEMENT, TRANSMISSION CONTROL PROTOCOL DATA, AND USER DATAGRAM PROTOCOL DATA

(71) Applicant: QUALCOMM Incorporated, San Diego, CA (US)

(72) Inventors: Madhan JAGANATHAN, Cupertino, CA (US); Xiaolong HUANG, San Jose, CA (US); Srinivas KATAR, Fremont, CA (US); Nathaniel David HOUGHTON, San Jose, CA (US); Madhavan NAIR, Sunnyvale, CA (US); Hao ZHU, Milpitas, CA (US); Chao ZOU, San Jose, CA (US)

(21) Appl. No.: 15/862,505

(22) Filed: Jan. 4, 2018

(51) Int. Cl. H04L 29/06; H04L 12/801; H04L 12/853; H04L 1/18

(52) U.S. Cl. CPC H04L 69/163; H04L 47/193; H04L 2001/125; H04L 1/1854; H04L 47/2416

(57) ABSTRACT

In an aspect of the disclosure, a method, a computer-readable medium, and an apparatus are provided. The apparatus may determine a plurality of TCP ACKs, and at least one of TCP data or UDP data for a multi-user transmission to a set of STAs. The apparatus may allocate the plurality of TCP ACKs to a PPDU before allocating the at least one of the TCP data and the UDP data to the PPDU. In certain aspects, the plurality of TCP ACKs may be frequency division multiplexed in the PPDU. In certain other aspects, the apparatus may transmit, to the set of STAs, the multi-user transmission including at least the plurality of frequency division multiplexed TCP ACKs.

### BACKGROUND

### Field

The present disclosure relates generally to communication systems, and more particularly, to determining a number of resource units (RUs) to include in a physical layer convergence procedure (PLCP) protocol data unit (PPDU) for a multi-user transmission such that a maximum number of transmission control protocol (TCP) acknowledgement (ACK) transmissions are included in the PPDU before any TCP data or the one or more user datagram protocol (UDP) data are included in the PPDU.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

One transport layer protocol that may be used for wireless communication is the TCP. The TCP may include a signaling protocol at the transport layer. In certain implementations, TCP data packets received by an AP may be acknowledged via one or more TCP ACK transmissions.

In order to increase the efficiency at the medium access control (MAC) layer and/or to increase data rate, an AP may generate a multi-user transmission (e.g., orthogonal frequency-division multiple access (OFDMA) PPDU) that prioritizes scheduling/grouping of TCP data and UDP data before TCP ACK transmissions. In addition, TCP ACK transmissions may be packed into an RU such that no RU symbols remain unused, which may also increase MAC layer efficiency.

However, by prioritizing TCP data and UDP data before TCP ACK transmissions, and by packing TCP ACK transmissions into a single RU, a reduction in TCP transport layer efficiency may occur. For example, packing and transmitting TCP ACK transmissions in an RU such that no symbols remain unused may take longer than packing and transmitting TCP ACK transmissions in separate RUs that are transmitted concurrently. From the perspective of TCP transport layer efficiency, packing TCP ACK transmissions in an efficient manner (e.g., to increase MAC layer efficiency) has less impact than delivering TCP ACK transmissions as quickly as possible. Thus, there is a need to reduce the latency associated with acknowledging TCP data in order to increase the efficiency of the TCP.

In addition, when an AP determines that a UDP data transmission was not properly received by a STA, a UDP data retransmission may be given higher priority than pending TCP data and/or TCP ACK transmissions. However, by prioritizing a UDP data retransmission higher than pending TCP data transmission and/or TCP ACK transmissions, the efficiency of the TCP layer may be further reduced. Thus, there is a need to prioritize TCP ACK transmissions such that the efficiency of the TCP layer may be increased.

The present disclosure provides a solution by providing a scheduling, grouping, and/or prioritization of TCP ACK transmissions, TCP data, and UDP data that may increase the efficiency of the TCP.

In an aspect of the disclosure, a method, a computer-readable medium, and an apparatus are provided. The apparatus may determine a plurality of TCP ACKs, and at least one of TCP data or UDP data for a multi-user transmission to a set of STAs. The apparatus may allocate the plurality of TCP ACKs to a PPDU before allocating the at least one of the TCP data and the UDP data to the PPDU. In certain aspects, the plurality of TCP ACKs may be frequency division multiplexed in the PPDU. In certain other aspects, the apparatus may transmit, to the set of STAs, the multi-user transmission including at least the plurality of frequency division multiplexed TCP ACKs.

### BRIEF DESCRIPTION OF THE DRAWINGS

FIG. 1 shows an example wireless communication system in which aspects of the present disclosure may be employed.

FIG. 2 is a diagram illustrating a scheduling, grouping, and/or prioritization technique for a multi-user transmission that maximizes MAC layer efficiency rather than TCP layer efficiency.

FIG. 3 is a diagram illustrating a scheduling, grouping, and/or prioritization technique for a multi-user transmission that maximizes TCP layer efficiency rather than MAC layer efficiency in accordance with certain aspects of the disclosure.

FIG. 4 illustrates a data flow for scheduling, grouping, and/or prioritization for a multi-user transmission that may maximize TCP layer efficiency rather than MAC layer efficiency in accordance with certain aspects of the disclosure.

FIG. 5 is an example functional block diagram of a wireless communication device 502 that may be configured to implement a scheduling, grouping, and/or prioritization technique that may maximize TCP layer efficiency rather than MAC layer efficiency within the wireless communication system 100 of FIG. 1

FIG. 6 is a flowchart of an example method for scheduling, grouping, and/or prioritization technique that may be used to maximize TCP layer efficiency in accordance with certain aspects of the present disclosure.

FIG. 7 is a functional block diagram of an example communication device that may be configured to implement a scheduling, grouping, and/or prioritization technique that may be used to maximize TCP layer efficiency in accordance with certain aspects of the present disclosure.

### DETAILED DESCRIPTION

Various aspects of the systems, apparatuses, computer-readable media, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol, and/or a wired protocol.

In some aspects, wireless signals may be transmitted according to a WLAN protocol (e.g., IEEE 802.11) using orthogonal frequency-division multiplexing (OFDM), direct-sequence spread spectrum (DSSS) communications, a combination of OFDM and DSSS communications, or other schemes. In one aspect, the physical (PHY) layer may use the DSSS to achieve a data rate (e.g., PHY rate) of, e.g., 11 Mbps. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, e.g., signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. The devices may also be used for surveillance, to enable extended-range Internet connectivity (e.g. for use with hotspots), or to implement machine-to-machine communications.

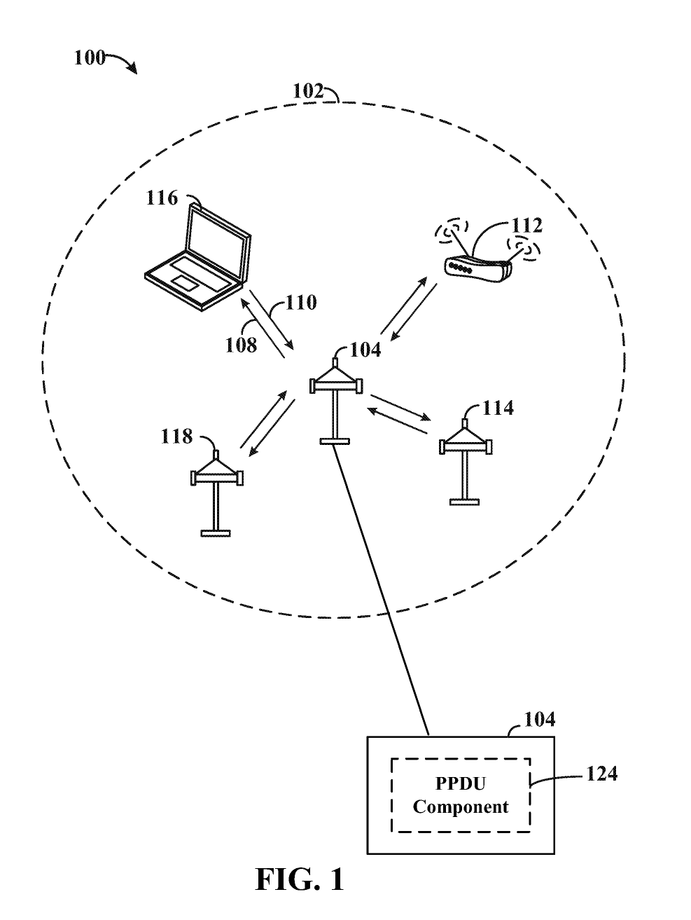

FIG. 1 shows an example wireless communication system 100 in which aspects of the present disclosure may be employed. The wireless communication system 100 may operate pursuant to a wireless standard, for example the 802.11 standard. The wireless communication system 100 may include a first device (e.g., AP 104 or STA 112, 116) that communicates with a second device (e.g., STA 112, 116 or AP 104).

A variety of processes and methods may be used for transmissions in the wireless communication system 100 between the AP 104 and the STAs. For example, signals may be sent and received between the AP 104 and the STAs in accordance with OFDM/orthogonal frequency-division multiple access (OFDMA) techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The APs 104, 114, 118 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 116) may be required to associate with the AP 104 in order to send communications to and/or to receive communications from the AP 104. In one aspect, information for associating is included in a beacon broadcast by the AP 104. To receive such a beacon, the STA 116 may, for example, perform a broad coverage search over a coverage region. A search may also be performed by the STA 116 by sweeping a coverage region in a lighthouse fashion, for example. After receiving the information for associating, the STA 116 may transmit a reference signal, such as an association probe or request, to the AP 104. In some aspects, the AP 104 may use backhaul services, for example, to communicate with a larger network, such as the Internet or a public switched telephone network (PSTN).

In certain implementations, the AP 104 may include one or more components for performing various functions. For example, the AP 104 may include a PPDU component 124 configured to perform procedures related to scheduling and grouping of TCP ACK transmissions, TCP data transmissions, and UDP data transmissions. In certain aspects, the PPDU component 124 may be configured to determine a plurality of TCP ACKs, and at least one of TCP data or UDP data for a multi-user transmission to a set of STAs. In certain configurations, the plurality of TCP ACKs may be maintained in at least one first queue, the TCP data may be maintained in a second queue, and the UDP data may be maintained in a third queue. In certain other configurations, each STA in the set of STAs may be assigned a different queue. In certain other aspects, the PPDU component 124 may be configured to allocate the plurality of TCP ACKs to a PPDU before allocating the at least one of the TCP data and the UDP data to the PPDU. In certain configurations, the plurality of TCP ACKs may be frequency division multiplexed in the PPDU. In certain other aspects, the PPDU component 124 may be configured to transmit, to the set of STAs, the multi-user transmission including at least the plurality of frequency division multiplexed TCP ACKs. In certain other aspects, the PPDU component 124 may be configured to allocate the UDP data in the multi-user transmission. In certain other aspects, the PPDU component 124 may be configured to allocate the TCP data to a subsequent PPDU before allocating a UDP data retransmission to the subsequent PPDU. In certain other aspects, the PPDU component 124 may be configured to transmit, to the set of STAs, the subsequent multi-user transmission including at least the TCP data.

In a Wi-Fi network, wireless devices such as APs and STAs may perform a clear channel assessment (CCA) to determine whether a transmission channel is busy or idle for purposes of determining whether data may be transmitted to another wireless device. A CCA has two components: carriers sense (CS) and energy detection. Carrier sense refers to an ability of a wireless device (e.g., AP or STA) to detect and decode incoming Wi-Fi signal preambles, signals which enable the receiver to acquire a wireless signal from and synchronize with the transmitter, from other wireless devices. For example, a first AP may broadcast a Wi-Fi signal preamble, and the Wi-Fi signal preamble may be detected by a second AP or a STA. Similarly, a third AP may broadcast a Wi-Fi signal preamble, and the Wi-Fi signal preamble may be detected by the second AP. When the second AP detects one or more of the Wi-Fi signal preambles, the second AP may determine that the transmission channel is busy and not transmit data. The CCA may remain busy for the length of a transmission frame associated with the Wi-Fi signal preambles.

The second component of CCA is energy detection, which refers to the ability of a wireless device to detect an energy level present on a transmission channel. The energy level may be based on different interference sources, Wi-Fi transmissions, a noise floor, and/or ambient energy. Wi-Fi transmissions may include unidentifiable Wi-Fi transmissions that have been corrupted or are so weak that the transmission can no longer be decoded. Unlike carrier sense, in which the exact length of time for which a transmission channel is busy may be known, energy detection uses periodic sampling of a transmission channel to determine if the energy still exists. Additionally, energy detection may require at least one threshold used to determine whether the reported energy level is adequate to report the transmission channel as busy or idle. This energy level may be referred to as the ED level/ED threshold level or the CCA sensitivity level. For example, if an ED level is above a threshold, a wireless device may defer to other devices by refraining from transmitting.

One transport layer protocol that may be used for wireless communication is the TCP. The TCP may include a signaling protocol at the transport layer. In certain implementations, TCP data packets received by an AP may be acknowledged via one or more TCP ACK transmissions.

In order to increase the efficiency at the MAC layer and/or to increase the data rate, an AP may generate a multi-user transmission (e.g., OFDMA PPDU) that prioritizes, schedules, and/or groups TCP data and UDP data before TCP ACK transmissions. In addition, multiple TCP ACK transmissions may be packed into an RU (e.g., frequency division multiplexed within the RU and/or PPDU) such that no RU symbols remain unused, which may also increase MAC layer efficiency.

However, by prioritizing TCP data and UDP data before TCP ACK transmissions, and by frequency division multiplexing TCP ACK transmissions into the PPDU, a reduction in TCP transport layer efficiency may occur. For example, packing and transmitting TCP ACK transmissions in an RU such that no symbols remain unused may take longer than packing and transmitting TCP ACK transmissions in separate RUs that are transmitted concurrently. From the perspective of TCP transport layer efficiency, packing TCP ACK transmissions in an efficient manner (e.g., to increase MAC layer efficiency) has less impact than delivering TCP ACK transmissions as quickly as possible. Thus, there is a need to reduce the latency associated with acknowledging TCP data in order to increase the efficiency of the TCP.

In addition, when an AP determines that a UDP data transmission was not properly received by a STA, a UDP data retransmission may be given higher priority than a TCP data transmission and/or a TCP ACK transmission. However, by prioritizing UDP data retransmission higher than a TCP data transmission and/or a TCP ACK transmission, the efficiency of the TCP layer may be further reduced. Thus, there is a need to prioritize TCP ACK transmissions such that the efficiency of the TCP layer may be increased.

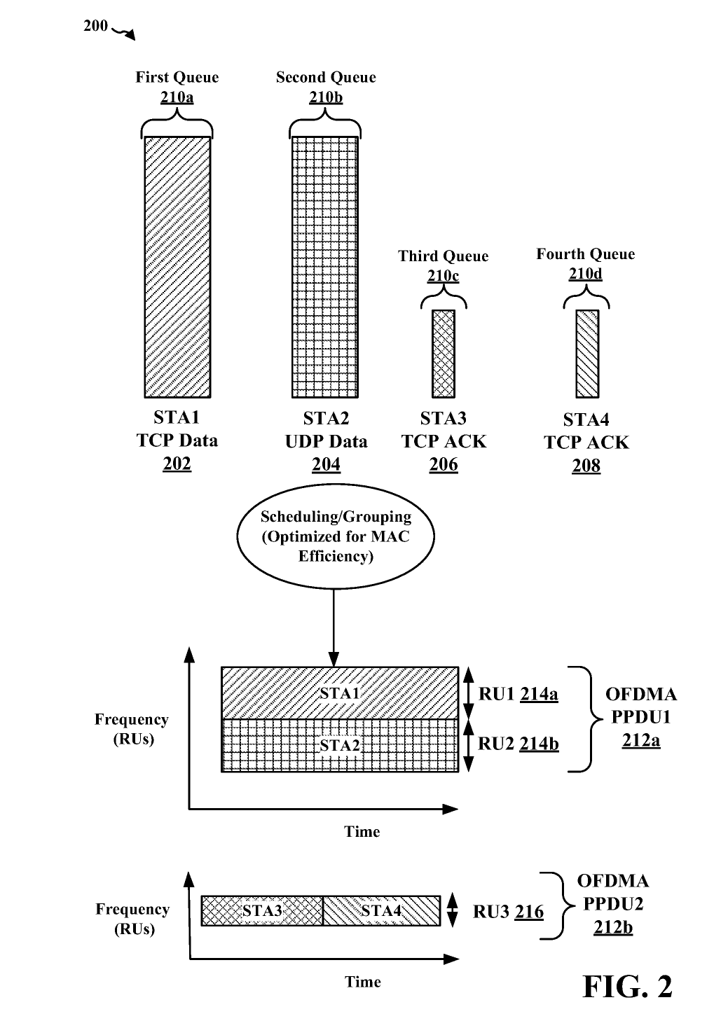

FIG. 2 is a diagram 200 illustrating a scheduling, grouping, and/or prioritization technique for a multi-user transmission that maximizes MAC layer efficiency rather than TCP layer efficiency. For example, the technique may be performed by an AP that transmits a multi-user transmission to a plurality of STAs.

In the example illustrated in FIG. 2, the AP may maintain TCP data 202 for STA1 in a first queue 210a, UDP data 204 for STA2 in a second queue 210b, a TCP ACK transmission 206 for STA3 in a third queue 210c, and a TCP ACK transmission 208 for STA4 in a fourth queue 210d. In order to maximize MAC layer efficiency, the AP may allocate a first RU (RU1) 214a of a first OFDMA PPDU (OFDMA PPDU1) 212a for the TCP data 202, and a second RU (RU2) 214b of the OFDMA PPDU1 212a for the UDP data 204. The OFDMA PPDU1 212a may then be transmitted to STA1 and STA2.

After the TCP data 202 and the UDP data 204 have been transmitted, the AP may group the TCP ACK transmission 206 for STA3 and the TCP ACK transmission 208 for STA4 in a third RU (RU3) 216 for transmission to STA3 and STA4 in second OFDMA PPDU (OFDMA PPDU2) 212b. The OFDMA PPDU2 212b may then be transmitted to STA3 and STA4.

Using the technique illustrated in FIG. 2, the MAC layer efficiency and/or the data rate may be increased by prioritizing, scheduling, and/or grouping TCP data and UDP data before TCP ACK transmissions. In addition, TCP ACK transmissions may be packed into an RU such that no RU symbols remain unused, which may also increase MAC layer efficiency.

However, using the technique illustrated in FIG. 2, TCP layer efficiency may be reduced because the TCP ACK transmissions 206, 208 are delayed until after the transmission of the TCP data 202 and the UDP data 204. Furthermore, TCP layer efficiency may be reduced because the TCP ACK transmissions 206, 208 are transmitted in the same RU, rather than in separate RUs transmitted concurrently in the time domain.

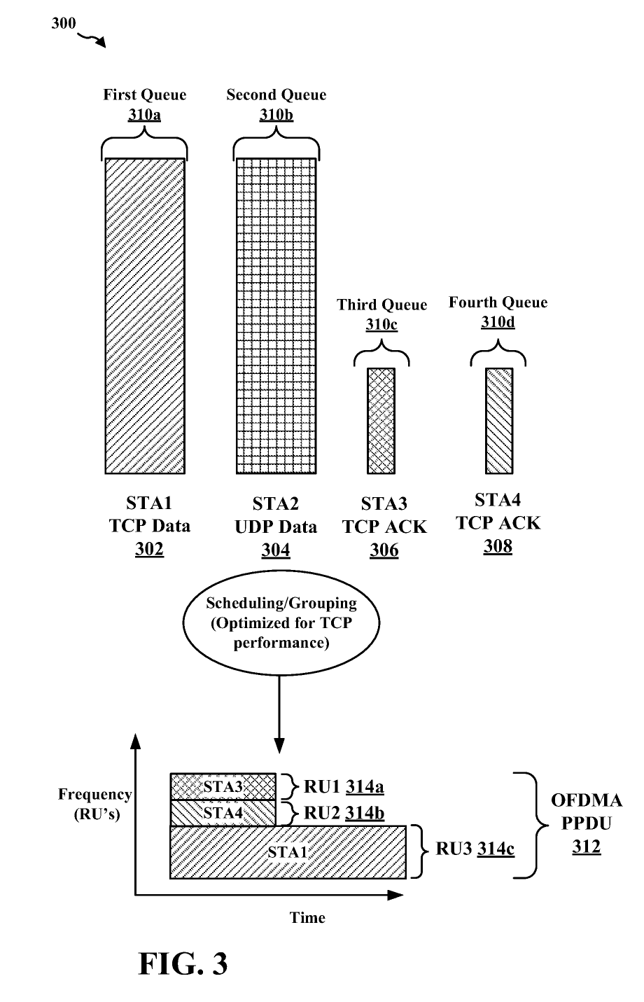

The present disclosure provides a solution by providing a scheduling, grouping, and/or prioritization of TCP ACK transmissions, TCP data, and UDP data that may increase the TCP layer efficiency, as described below with reference to FIG. 3.

FIG. 3 is a diagram 300 illustrating a scheduling, grouping, and/or prioritization technique for a multi-user transmission that maximizes TCP layer efficiency rather than MAC layer efficiency in accordance with certain aspects of the disclosure. For example, the technique may be performed by an AP (e.g., AP 104, 402, wireless communication device 502, 700) that transmits a multi-user transmission to a plurality of STAs (e.g., STA 112, 116).

In the example illustrated in FIG. 3, the AP may maintain TCP data 302 for STA1 in a first queue 310a, UDP data 304 for STA2 in a second queue 310b, a TCP ACK transmission 306 for STA3 in a third queue 310c, and a TCP ACK transmission 308 for STA4 in a fourth queue 310d. In order to maximize TCP layer efficiency, the AP may allocate a maximum number of RUs for each of the TCP ACK transmissions that can be accommodated by a total bandwidth of an OFDMA PPDU 312.

By way of an illustrative example, assume the OFDMA PPDU 312 has a bandwidth of 12 MHz, an RU allocated for a TCP ACK transmission (e.g., RU1 314a and RU2 314b) has a bandwidth of 3 MHz, an RU allocated for TCP data (e.g., RU3 314c) has a bandwidth of 6 MHz, and an RU allocated for UDP data has a bandwidth of 6 MHz. In addition, assume that an OFDMA PPDU has a transmission duration of 10 ms, the first RU allocated for a TCP ACK transmission has a duration of 5 ms, the second RU allocated for TCP data has a duration of 10 ms, and that a third RU allocated for UDP data has a duration of 10 ms.

Here, the AP may allocate a first RU (RU1) 314a for the TCP ACK transmission 306 for STA3 and a second RU (RU2) 314b for the TCP ACK transmission 308 for STA4, such that the TCP ACK transmission 306 for STA3 and the TCP ACK transmission 308 for STA4 are frequency division multiplexed. In the present example, because there are no more TCP ACK transmissions maintained in any of the queues, the AP may determine if there is sufficient bandwidth remaining in the OFDMA PPDU 312 to accommodate either or both of the TCP data 302 and/or the UDP data 304. Because RU1 314a and RU2 314b occupy 6 MHz of the 12 MHz bandwidth of the OFDMA PPDU 312, the AP may determine that there is sufficient bandwidth to accommodate the TCP data 302 in a third RU (RU3) 314c that has a 6 MHz bandwidth. The OFDMA PPDU 312 may then be transmitted to STA1, STA3, and STA4.

However, if the AP determines that there is not sufficient bandwidth for either the TCP data 302 or the UDP data 304, the AP may allocate RUs in a subsequent OFDMA PPDU for the TCP data 302 and the UDP data 304.

In an alternative illustrative example, assume the OFDMA PPDU 312 has a maximum PPDU payload of 50 bytes, the TCP ACK transmission 306 for STA3 has a payload of 25 bytes, the TCP ACK transmission 308 for STA4 has a payload of 25 bytes, the TCP data 302 for STA1 has a payload of 40 bytes, and the UDP data 304 for STA2 has a payload of 30 bytes. Here, the AP may allocate a first PPDU for the TCP ACK transmissions 306, 308 because a sum of the payloads of the TCP ACK transmissions 306, 308 (e.g., 25 bytes+25 bytes=50 bytes) does not exceed the maximum PPDU payload of 50 bytes. However, the TCP data 302 for STA 1 and/or the UDP data 304 for STA2 may not be included in the first PPDU because the sum of the payloads of the TCP ACK transmissions 306, 308 meets the maximum PPDU payload. A sum of the payloads of the TCP data 302 for STA1 and the UDP data 304 for STA2 (e.g., 40 bytes+30 bytes=70 bytes) exceeds the maximum PPDU payload (e.g., 50 bytes), and hence, may not be included in the same PPDU. Instead, the AP may allocate a second PPDU for the TCP data 302 for STA1 and a third PPDU for the UDP data 304 for STA2. In the alternative illustrative example, the AP may transmit the first PPDU that includes the TCP ACK transmissions 306, 308 before transmitting the second PPDU that includes the TCP data 302 for STA1 and/or the third PPDU that includes the UDP data 304 for STA2.

Using the technique illustrated in FIG. 3, TCP layer efficiency may be increased because the TCP ACK transmissions 306, 308 are given a higher priority than the TCP data 302 and the UDP data 304. In other words, the TCP ACK transmissions 306, 308 will be transmitted in the earliest available OFDMA PPDU. Furthermore, TCP layer efficiency may be increase because the TCP ACK transmissions 306, 308 are concurrently transmitted in separate RUs even though RU symbols in the time domain remain unused.

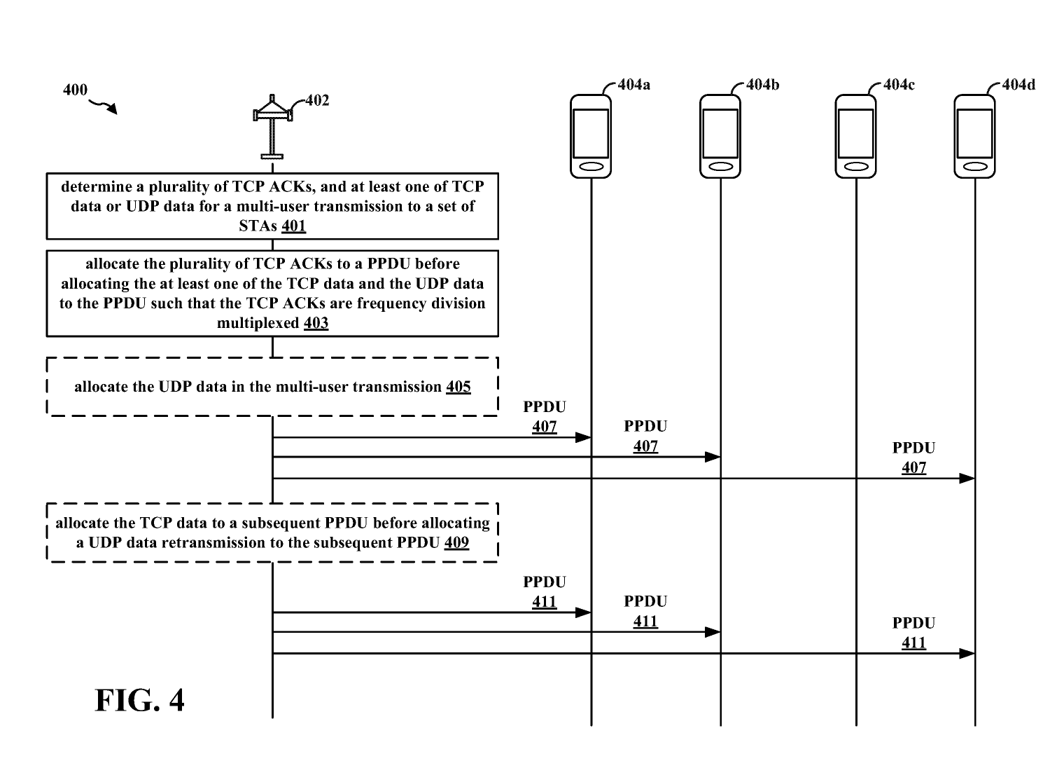

FIG. 4 illustrates a data flow 400 for a scheduling, grouping, and/or prioritization technique that may be used to maximize TCP layer efficiency in accordance with certain aspects of the disclosure. For example, the technique may be performed by an AP 402 that transmits an OFDMA PPDU 407, 411 (e.g., multi-user transmission) to a first STA 404a, a second STA 404b, a third STA 404c, and a fourth STA 404d. The AP 402 may correspond to, e.g., AP 104, wireless communication device 502, 700. The first STA 404a may correspond to, e.g., STA 112, 116, STA3 in FIG. 3. The second STA 404b may correspond to, e.g., STA 112, 116, STA1 in FIG. 3. The third STA 404c may correspond to, e.g., STA 112, 116, STA2 in FIG. 3. The fourth STA 404d may correspond to, e.g., STA 112, 116, STA4 in FIG. 3. The AP 402 may include multiple queues (e.g., buffers) that correspond to, e.g., the first queue 310a, the second queue 310b, the third queue 310c, and the fourth queue 310d in FIG. 3. Each of the queues at the AP 402 may be configured to maintain one or more of TCP data, UDP data, or TCK ACK transmissions. Each of the queues at the AP 402 may be associated with a different STA. The AP 402 may include more or fewer than four queues without departing from the scope of the present disclosure. Although four STAs are illustrated as being scheduled for a OFDMA PPDU in FIG. 4, more or fewer than four STAs may be scheduled for an OFDMA PPDU without departing from the scope of the present disclosure. In FIG. 4, optional operations are indicated with dashed lines.

Referring to FIG. 4, the AP 402 may determine (at 401) a plurality of TCP ACKs, and at least one of TCP data or UDP data for a multi-user transmission to a set of STAs. For example, referring to FIG. 3, the AP 402 may determine (at 401) a first TCP ACK transmission 306 that is maintained the third queue 310c for the first STA 404a, TCP data 302 that is maintained in the first queue 310a for the second STA 404b, UDP data 304 that is maintained in the second queue 310b for the third STA 404c, and a second TCP ACK transmission 308 that is maintained in the fourth queue 310d for the fourth STA 404d.

In certain aspects, the AP 402 may allocate (at 403) the plurality of TCP ACKs to a PPDU before allocating the at least one of the TCP data and the UDP data to the PPDU such that the plurality of TCP ACKs may be frequency division multiplexed in the PPDU. For example, referring to FIG. 3, the AP 402 may allocate a first RU (RU1) 314a for the TCP ACK transmission 306 for STA3 and a second RU (RU2) 314b for the TCP ACK transmission 308 for STA4, such that the TCP ACK transmission 306 for STA3 and the TCP ACK transmission 308 for STA4 are frequency division multiplexed. In the present example, because there are no more TCP ACK transmissions maintained in any of the queues, the AP 402 may determine if there is sufficient bandwidth remaining in the OFDMA PPDU 312 to accommodate either or both of the TCP data 302 and/or the UDP data 304. Because RU1 314a and RU2 314b occupy 6 MHz of the 12 MHz bandwidth of the OFDMA PPDU 312, the AP may determine that there is sufficient bandwidth to accommodate the TCP data 302 in a third RU (RU3) 314c that has a 6 MHz bandwidth. The OFDMA PPDU 312 may then be transmitted to STA1, STA3, and STA4.

In certain aspects, the AP 402 may allocate (at 405) the UDP data in the PPDU. In certain aspects, the AP 402 may allocated (at 405) UDP data in the PPDU when there is no TCP data to send to any STAs. For example, referring to FIG. 3, the AP 402 may allocate RU1 314a for the TCP ACK transmission 306 for STA3 and RU2 314b for the TCP ACK transmission 308 for STA4, such that the TCP ACK transmission 306 for STA3 and the TCP ACK transmission 308 for STA4 are frequency division multiplexed. In the present example, because there are no more TCP ACK transmissions maintained in any of the queues, the AP 402 may determine if there is sufficient bandwidth remaining in the OFDMA PPDU 312 to accommodate either or both of the TCP data 302 and/or the UDP data 304. Because RU1 314a and RU2 314b occupy 6 MHz of the 12 MHz bandwidth of the OFDMA PPDU 312, the AP may determine that there is sufficient bandwidth to accommodate the UDP data 304 in RU3 314c that has a 6 MHz bandwidth when there is no TCP data to transmit. The OFDMA PPDU 312 may then be transmitted to STA2, STA3, and STA4.

In certain other aspects, the AP 402 may transmit (at 407), to the set of STAs, the multi-user transmission including at least the plurality of frequency division multiplexed TCP ACKs. For example, referring to FIG. 3, the AP 402 may transmit the OFDMA PPDU 312 may then be transmitted to STA1, STA2, STA3, and/or STA4, depending on the allocation of the OFDMA PPDU 312.

In certain other configurations, the AP 402 may allocate (at 409) the TCP data to a subsequent PPDU before allocating a UDP data retransmission to the subsequent PPDU. For example, referring to FIG. 3, the AP 402 may allocate RU1 314a for the TCP ACK transmission 306 for STA3 and RU2 314b for the TCP ACK transmission 308 for STA4, such that the TCP ACK transmission 306 for STA3 and the TCP ACK transmission 308 for STA4 are frequency division multiplexed. In the present example, because there are no more TCP ACK transmissions maintained in any of the queues, the AP 402 may determine if there is sufficient bandwidth remaining in the OFDMA PPDU 312 to accommodate either or both of the TCP data 302 and/or the UDP data 304. Because RU1 314a and RU2 314b occupy 6 MHz of the 12 MHz bandwidth of the OFDMA PPDU 312, the AP 402 may determine that there is sufficient bandwidth to accommodate the TCP data 302 in RU3 314c and/or a UDP data retransmission 304 (e.g., initially transmitted in a prior multi-user transmission). In order to increase TCP layer efficiency, the AP 402 may allocate the TCP data 302 in the OFDMA PPDU 312 prior to allocating the UDP data retransmission 304 in the OFDMA PPDU 312. If the OFDMA PPDU 312 has sufficient bandwidth to accommodate both the TCP data 302 and the UDP data retransmission 304, then the UDP data retransmission 304 may be allocated to the OFDMA PPDU 312 after the allocation of the TCP data 302 to the OFDMA PPDU 312.

In certain other configurations, the AP 402 may transmit (at 411), to the set of STAs, the subsequent multi-user transmission including at least the TCP data. For example, referring to FIG. 3, the AP 402 may transmit the OFDMA PPDU 312 may then be transmitted to STA1, STA2, STA3, and/or STA4, depending on the allocation of the PPDU.

Using the technique(s) described supra with respect to FIG. 4, a wireless communication system of the present disclosure may provide scheduling, grouping, and/or prioritization of TCP ACK transmissions, TCP data, and UDP data that may increase the TCP layer efficiency.

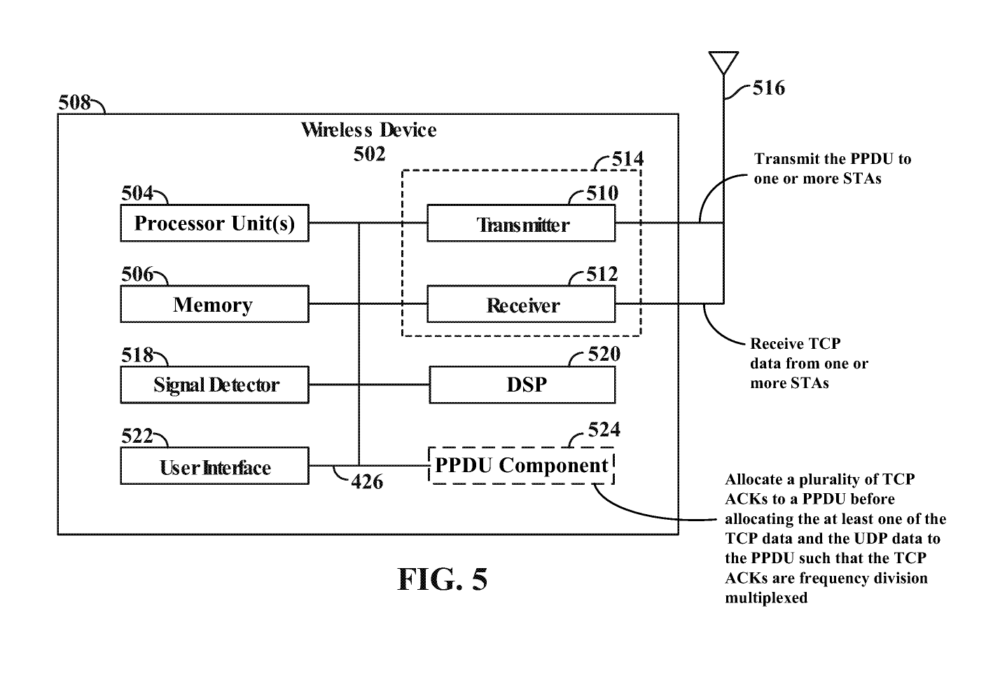

FIG. 5 shows an example functional block diagram of a wireless communication device 502 that may be configured to differentiate the scheduling, grouping, and/or prioritization of TCP ACK transmissions, TCP data transmissions, and UDP data transmissions within the wireless communication system 100 of FIG. 1. The wireless communication device 502 is an example of a device that may be configured to implement the various methods described herein. For example, the wireless communication device 502 may correspond to, e.g., AP 104, 402, the wireless communication device 700.

The wireless communication device 502 may include a processor 504 which controls operation of the wireless communication device 502. The processor 504 may also be referred to as a central processing unit (CPU). Memory 506, which may include both read-only memory (ROM) and random access memory (RAM), may provide instructions and data to the processor 504. A portion of the memory 506 may also include non-volatile random access memory (NVRAM). The processor 504 may perform logical and arithmetic operations based on program instructions stored within the memory 506. The instructions in the memory 506 may be executable (by the processor 504, for example) to implement the methods described herein.

The processor 504 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless communication device 502 may also include a housing 508, and the wireless communication device 502 may include a transmitter 510 and/or a receiver 512 to allow transmission and reception of data between the wireless communication device 502 and a remote device (e.g., a STA). The transmitter 510 and the receiver 512 may be combined into a transceiver 514. An antenna 516 may be attached to the housing 508 and electrically coupled to the transceiver 514. The wireless communication device 502 may also include multiple transmitters, multiple receivers, multiple transceivers, and/or multiple antennas.

The wireless communication device 502 may also include a signal detector 518 that may be used to detect and quantify the level of signals received by the transceiver 514 or the receiver 512. The signal detector 518 may detect such signals as total energy, energy per subcarrier per symbol, power spectral density, and other signals. The wireless communication device 502 may also include a DSP 520 for use in processing signals. The DSP 520 may be configured to generate a packet for a multi-user transmission. In some aspects, the packet may comprise a PPDU.

The wireless communication device 502 may further comprise a user interface 522 in some aspects. The user interface 522 may comprise a keypad, a microphone, a speaker, and/or a display. The user interface 522 may include any element or component that conveys information to a user of the wireless communication device 502 and/or receives input from the user.

In certain implementations, the wireless communication device 502 may include one or more components for performing various functions. For example, the wireless communication device 502 may include a PPDU component 524 configured to perform procedures related to scheduling and grouping of TCP ACK transmissions, TCP data transmissions, and UDP data transmissions. In certain aspects, the PPDU component 524 may be configured to determine a plurality of TCP ACKs, and at least one of TCP data or UDP data for a multi-user transmission to a set of STAs. In certain configurations, the plurality of TCP ACKs may be maintained in at least one first queue, the TCP data may be maintained in a second queue, and the UDP data may be maintained in a third queue. In certain other configurations, each STA in the set of STAs may be assigned a different queue. In certain other aspects, the PPDU component 524 may be configured to allocate the plurality of TCP ACKs to a PPDU before allocating the at least one of the TCP data and the UDP data to the PPDU. In certain configurations, the plurality of TCP ACKs may be frequency division multiplexed in the PPDU. In certain other aspects, the PPDU component 524 may be configured to transmit, to the set of STAs, the multi-user transmission including at least the plurality of frequency division multiplexed TCP ACKs. In certain other aspects, the PPDU component 524 may be configured to allocate the UDP data in the multi-user transmission. In certain other aspects, the PPDU component 524 may be configured to allocate the TCP data to a subsequent PPDU before allocating a UDP data retransmission to the subsequent PPDU. In certain other aspects, the PPDU component 524 may be configured to transmit, to the set of STAs, the subsequent multi-user transmission including at least the TCP data.

The various components of the wireless communication device 502 may be coupled together by a bus system 526. The bus system 526 may include a data bus, for example, as well as a power bus, a control signal bus, and a status signal bus in addition to the data bus. Components of the wireless communication device 502 may be coupled together or accept or provide inputs to each other using some other mechanism.

Although a number of separate components are illustrated in FIG. 5, one or more of the components may be combined or commonly implemented. For example, the processor 504 may be used to implement the functionality described above with respect to the processor 504, but also to implement the functionality described above with respect to the signal detector 518, the DSP 520, the user interface 522, and/or the PPDU component 524. Further, each of the components illustrated in FIG. 5 may be implemented using a plurality of separate elements.

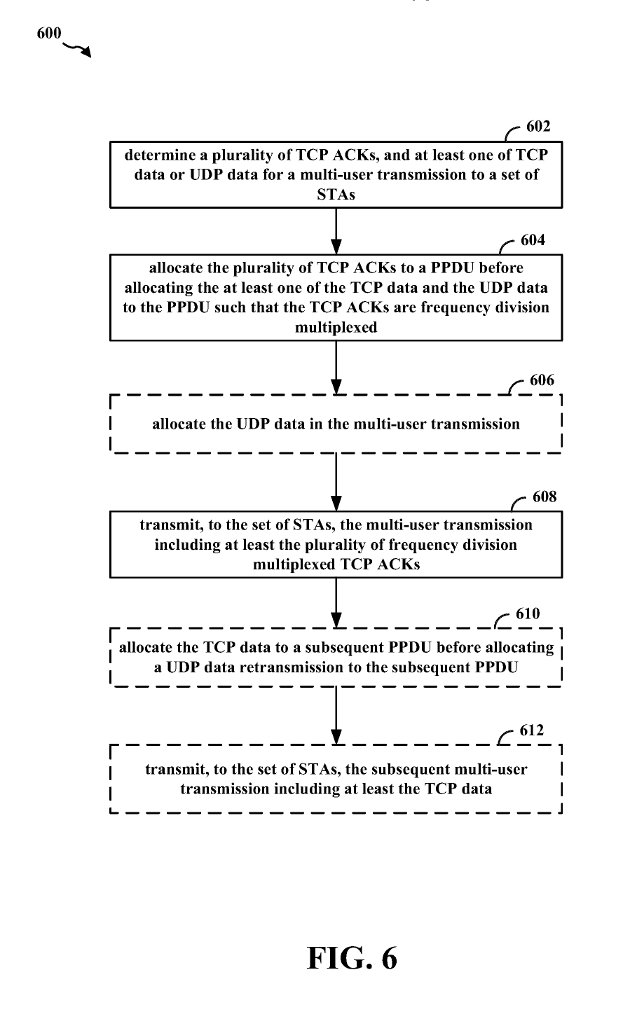

FIG. 6 is a flowchart of an example method 600 of scheduling, grouping, and/or prioritizing TCP ACK transmissions, TCP data transmissions, and UDP data transmissions in accordance with certain aspects of the disclosure. The method 600 may be performed by an AP (e.g., the AP 104, 402, the wireless communication device 502, 700) in communication with at least one STA (e.g., the STA 112, 116, 404a, 404b, 404c, 404d). In FIG. 6, optional operations are indicated with dashed lines.

At 602, the AP may determine a plurality of TCP ACKs, and at least one of TCP data or UDP data for a multi-user transmission to a set of STAs. In certain aspects, the plurality of TCP ACKs may be maintained in at least one first queue, the TCP data may be maintained in a second queue, and the UDP data may be maintained in a third queue. In certain other aspects, each STA in the set of STAs may be assigned a different queue. For example, referring to FIGS. 3 and 4, the AP 402 may determine (at 401) a plurality of TCP ACKs, and at least one of TCP data or UDP data for a multi-user transmission to a set of STAs. In certain aspects, the AP 402 may determine (at 401) a first TCP ACK transmission 306 that is maintained the third queue 310c for the first STA 404a, TCP data 302 that is maintained in the first queue 310a for the second STA 404b, UDP data 304 that is maintained in the second queue 310b for the third STA 404c, and a second TCP ACK transmission 308 that is maintained in the fourth queue 310d for the fourth STA 404d.

At 604, the AP may allocate the plurality of TCP ACKs to a PPDU before allocating the at least one of the TCP data and the UDP data to the PPDU such that the plurality of TCP ACKs may be frequency division multiplexed in the PPDU. For example, referring to FIGS. 3, and 4, the AP 402 may allocate (at 403) the plurality of TCP ACKs to a PPDU before allocating the at least one of the TCP data and the UDP data to the PPDU such that the plurality of TCP ACKs may be frequency division multiplexed in the PPDU. In certain configurations, the AP 402 may allocate a first RU (RU1) 314a for the TCP ACK transmission 306 for STA3 and a second RU (RU2) 314b for the TCP ACK transmission 308 for STA4, such that the TCP ACK transmission 306 for STA3 and the TCP ACK transmission 308 for STA4 are frequency division multiplexed. In the present example, because there are no more TCP ACK transmissions maintained in any of the queues, the AP 402 may determine if there is sufficient bandwidth remaining in the OFDMA PPDU 312 to accommodate either or both of the TCP data 302 and/or the UDP data 304. Because RU1 314a and RU2 314b occupy 6 MHz of the 12 MHz bandwidth of the OFDMA PPDU 312, the AP may determine that there is sufficient bandwidth to accommodate the TCP data 302 in a third RU (RU3) 314c that has a 6 MHz bandwidth. The OFDMA PPDU 312 may then be transmitted to STA1, STA3, and STA4.

At 606, the AP may allocate the UDP data in the PPDU. For example, referring to FIGS. 3 and 4, the AP 402 may allocate (at 405) the UDP data in the PPDU. In certain aspects, the AP 402 may allocated (at 405) UDP data in the PPDU when there is no TCP data to send to any STAs. For example, the AP 402 may allocate RU1 314a for the TCP ACK transmission 306 for STA3 and RU2 314b for the TCP ACK transmission 308 for STA4, such that the TCP ACK transmission 306 for STA3 and the TCP ACK transmission 308 for STA4 are frequency division multiplexed. In the present example, because there are no more TCP ACK transmissions maintained in any of the queues, the AP 402 may determine if there is sufficient bandwidth remaining in the OFDMA PPDU 312 to accommodate either or both of the TCP data 302 and/or the UDP data 304. Because RU1 314a and RU2 314b occupy 6 MHz of the 12 MHz bandwidth of the OFDMA PPDU 312, the AP may determine that there is sufficient bandwidth to accommodate the UDP data 304 in RU3 314c that has a 6 MHz bandwidth when there is no TCP data to transmit. The OFDMA PPDU 312 may then be transmitted to STA2, STA3, and STA4.

At 608, the AP may transmit, to the set of STAs, the multi-user transmission including at least the plurality of frequency division multiplexed TCP ACKs. For example, referring to FIGS. 3 and 4, the AP 402 may transmit (at 407), to the set of STAs, the multi-user transmission including at least the plurality of frequency division multiplexed TCP ACKs. For example, referring to FIG. 3, the AP 402 may transmit the OFDMA PPDU 312 may then be transmitted (at 407) to STA1, STA2, STA3, and/or STA4, depending on the allocation of the OFDMA PPDU 312.

At 610, the AP may allocate the TCP data to a subsequent PPDU before allocating a UDP data retransmission to the subsequent PPDU. For example, referring to FIGS. 3 and 4, the AP 402 may allocate (at 409) the TCP data to a subsequent PPDU before allocating a UDP data retransmission to the subsequent PPDU. In certain configurations, the AP 402 may allocate (at 409) RU1 314a for the TCP ACK transmission 306 for STA3 and RU2 314b for the TCP ACK transmission 308 for STA4, such that the TCP ACK transmission 306 for STA3 and the TCP ACK transmission 308 for STA4 are frequency division multiplexed. In the present example, because there are no more TCP ACK transmissions maintained in any of the queues, the AP 402 may determine if there is sufficient bandwidth remaining in the OFDMA PPDU 312 to accommodate either or both of the TCP data 302 and/or the UDP data 304. Because RU1 314a and RU2 314b occupy 6 MHz of the 12 MHz bandwidth of the OFDMA PPDU 312, the AP 402 may determine that there is sufficient bandwidth to accommodate the TCP data 302 in RU3 314c and/or a UDP data retransmission 304 (e.g., initially transmitted in a prior multi-user transmission). In order to increase TCP layer efficiency, the AP 402 may allocate the TCP data 302 in the OFDMA PPDU 312 prior to allocating the UDP data retransmission 304 in the OFDMA PPDU 312. If the OFDMA PPDU 312 has sufficient bandwidth to accommodate both the TCP data 302 and the UDP data retransmission 304, then the UDP data retransmission 304 may be allocated to the OFDMA PPDU 312 after the allocation of the TCP data 302 to the OFDMA PPDU 312.

At 612, the AP may transmit, to the set of STAs, the subsequent multi-user transmission including at least the TCP data. For example, referring to FIGS. 3 and 4, the AP 402 may transmit (at 411) the OFDMA PPDU 312 may then be transmitted to STA1, STA2, STA3, and/or STA4, depending on the allocation of the PPDU.

Using the technique(s) described supra with respect to FIG. 6, a wireless communication system of the present disclosure may provide scheduling, grouping, and/or prioritization of TCP ACK transmissions, TCP data, and UDP data that may increase the TCP layer efficiency.

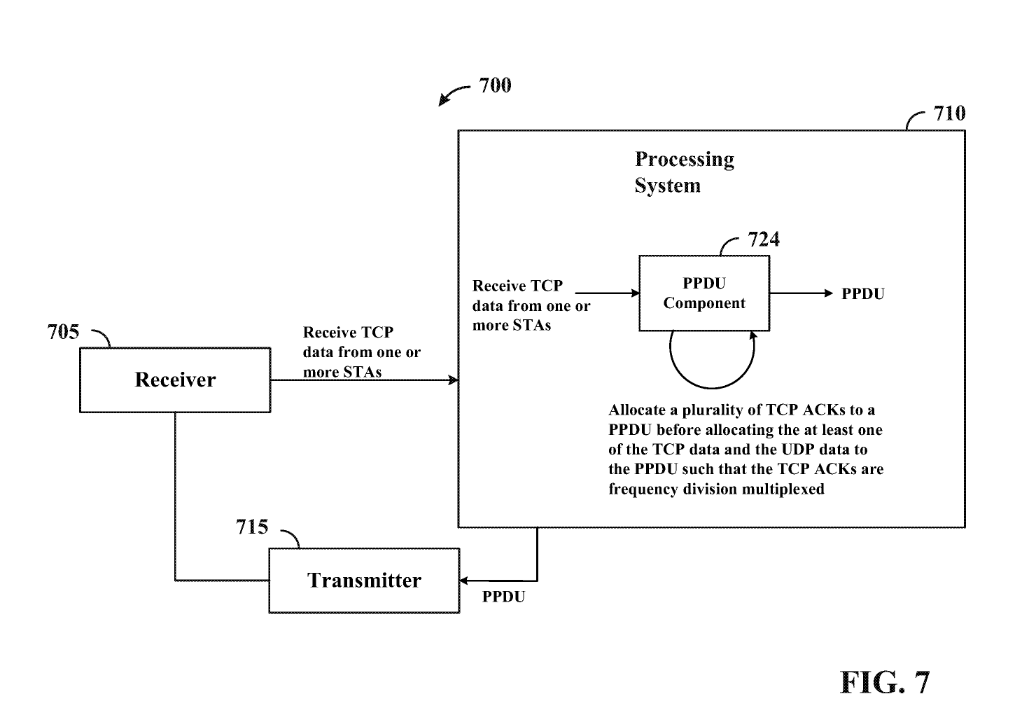

FIG. 7 is a functional block diagram of an example wireless communication device 700 that may differentiate the scheduling, grouping, and/or prioritization of TCP ACK transmissions, TCP data transmissions, and UDP data transmissions. The wireless communication device 700 may include a receiver 705, a processing system 710, and a transmitter 715. The processing system 710 may include a PPDU component 724.

In certain aspects, the processing system 710, the PPDU component 724, and/or the transmitter 715 may be configured to determine a plurality of TCP ACKs, and at least one of TCP data or UDP data for a multi-user transmission to a set of STAs. In certain configurations, the plurality of TCP ACKs may be maintained in at least one first queue, the TCP data may be maintained in a second queue, and the UDP data may be maintained in a third queue. In certain other configurations, each STA in the set of STAs may be assigned a different queue. In certain other aspects, the processing system 710, the PPDU component 724, and/or the transmitter 715 may be configured to allocate the plurality of TCP ACKs to a PPDU before allocating the at least one of the TCP data and the UDP data to the PPDU. In certain configurations, the plurality of TCP ACKs may be frequency division multiplexed in the PPDU. In certain other aspects, the processing system 710, the PPDU component 724, and/or the transmitter 715 may be configured to transmit, to the set of STAs, the multi-user transmission including at least the plurality of frequency division multiplexed TCP ACKs. In certain other aspects, the processing system 710, the PPDU component 724, and/or the transmitter 715 may be configured to allocate the UDP data in the multi-user transmission. In certain other aspects, the processing system 710, the PPDU component 724, and/or the transmitter 715 may be configured to allocate the TCP data to a subsequent PPDU before allocating a UDP data retransmission to the subsequent PPDU. In certain other aspects, the processing system 710, the PPDU component 724, and/or the transmitter 715 may be configured to transmit, to the set of STAs, the subsequent multi-user transmission including at least the TCP data.

The receiver 705, the processing system 710, the PPDU component 724, and/or the transmitter 715 may be configured to perform one or more functions discussed above with respect to operations 602, 604, 606, 608, 610, 612 of FIG. 6. The receiver 705 may correspond to the receiver 512. The processing system 710 may correspond to the processor 504. The transmitter 715 may correspond to the transmitter 510. The PPDU component 724 may correspond to the PPDU component 124, and/or the PPDU component 524.

In certain aspects, the wireless communication device 700 may include means for determining (e.g., the processing system 710, the PPDU component 724, and/or the transmitter 715) a plurality of TCP ACKs, and at least one of TCP data or UDP data for a multi-user transmission to a set of STAs. In certain configurations, the plurality of TCP ACKs may be maintained in at least one first queue, the TCP data may be maintained in a second queue, and the UDP data may be maintained in a third queue. In certain other configurations, each STA in the set of STAs may be assigned a different queue. In certain other aspects, the wireless communication device 700 may include means for allocating (e.g., the processing system 710, the PPDU component 724, and/or the transmitter 715) the plurality of TCP ACKs to a PPDU before allocating the at least one of the TCP data and the UDP data to the PPDU. In certain configurations, the plurality of TCP ACKs may be frequency division multiplexed in the PPDU. In certain other aspects, the wireless communication device 700 may include means for transmitting (e.g., the processing system 710, the PPDU component 724, and/or the transmitter 715), to the set of STAs, the multi-user transmission including at least the plurality of frequency division multiplexed TCP ACKs. In certain other aspects, the wireless communication device 700 may include means for allocating (e.g., the processing system 710, the PPDU component 724, and/or the transmitter 715) the UDP data in the multi-user transmission. In certain other aspects, the wireless communication device 700 may include means for allocating (e.g., the processing system 710, the PPDU component 724, and/or the transmitter 715) the TCP data to a subsequent PPDU before allocating a UDP data retransmission to the subsequent PPDU. In certain other aspects, the wireless communication device 700 may include means for transmitting (e.g., the processing system 710, the PPDU component 724, and/or the transmitter 715), to the set of STAs, the subsequent multi-user transmission including at least the TCP data.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of an access point (AP), comprising:
determining a plurality of transmission control protocol (TCP) acknowledgements (ACKs), and at least one of TCP data or user datagram protocol (UDP) data for a multi-user transmission to a set of stations (STAs);
allocating the plurality of TCP ACKs to a physical layer convergence procedure (PLCP) protocol data unit (PPDU) before allocating the at least one of the TCP data and the UDP data to the PPDU, the plurality of TCP ACKs being frequency division multiplexed in the PPDU; and
transmitting, to the set of STAs, the multi-user transmission including at least the plurality of frequency division multiplexed TCP ACKs.

2. The method of claim 1, wherein the plurality of TCP ACKs are maintained in at least one first queue, the TCP data is maintained in a second queue, and the UDP data is maintained in a third queue.

3. The method of claim 1, wherein each STA in the set of STAs is assigned a different queue.

4. The method of claim 1, further comprising:
allocating the UDP data in the multi-user transmission;
allocating the TCP data to a subsequent PPDU before allocating a UDP data retransmission to the subsequent PPDU; and
transmitting, to the set of STAs, the subsequent multi-user transmission including at least the TCP data.

5. An apparatus for wireless communication of an access point (AP), comprising:
means for determining a plurality of transmission control protocol (TCP) acknowledgements (ACKs), and at least one of TCP data or user datagram protocol (UDP) data for a multi-user transmission to a set of stations (STAs);
means for allocating the plurality of TCP ACKs to a physical layer convergence procedure (PLCP) protocol data unit (PPDU) before allocating the at least one of the TCP data and the UDP data to the PPDU, the plurality of TCP ACKs being frequency division multiplexed in the PPDU; and
means for transmitting, to the set of STAs, the multi-user transmission including at least the plurality of frequency division multiplexed TCP ACKs.

6. The apparatus of claim 5, wherein the plurality of TCP ACKs are maintained in at least one first queue, the TCP data is maintained in a second queue, and the UDP data is maintained in a third queue.

7. The apparatus of claim 5, wherein each STA in the set of STAs is assigned a different queue.

8. The apparatus of claim 5, further comprising:
means for allocating the UDP data in the multi-user transmission;
means for allocating the TCP data to a subsequent PPDU before allocating a UDP data retransmission to the subsequent PPDU; and
means for transmitting, to the set of STAs, the subsequent multi-user transmission including at least the TCP data.

9. An apparatus for wireless communication of an access point (AP), comprising:
a memory; and
at least one processor coupled to the memory and configured to:
determine a plurality of transmission control protocol (TCP) acknowledgements (ACKs), and at least one of TCP data or user datagram protocol (UDP) data for a multi-user transmission to a set of stations (STAs);
allocate the plurality of TCP ACKs to a physical layer convergence procedure (PLCP) protocol data unit (PPDU) before allocating the at least one of the TCP data and the UDP data to the PPDU, the plurality of TCP ACKs being frequency division multiplexed in the PPDU; and
transmit, to the set of STAs, the multi-user transmission including at least the plurality of frequency division multiplexed TCP ACKs.

10. The apparatus of claim 9, wherein the plurality of TCP ACKs are maintained in at least one first queue, the TCP data is maintained in a second queue, and the UDP data is maintained in a third queue.

11. The apparatus of claim 9, wherein each STA in the set of STAs is assigned a different queue.

12. The apparatus of claim 9, wherein the at least one processor is further configured to:
allocate the UDP data in the multi-user transmission;
allocate the TCP data to a subsequent PPDU before allocating a UDP data retransmission to the subsequent PPDU; and
transmit, to the set of STAs, the subsequent multi-user transmission including at least the TCP data.

13. A computer-readable medium storing computer executable code of an access point (AP), comprising code to:
determine a plurality of transmission control protocol (TCP) acknowledgements (ACKs), and at least one of TCP data or user datagram protocol (UDP) data for a multi-user transmission to a set of stations (STAs);
allocate the plurality of TCP ACKs to a physical layer convergence procedure (PLCP) protocol data unit (PPDU) before allocating the at least one of the TCP data and the UDP data to the PPDU, the plurality of TCP ACKs being frequency division multiplexed in the PPDU; and
transmit, to the set of STAs, the multi-user transmission including at least the plurality of frequency division multiplexed TCP ACKs.

14. The computer-readable medium of claim 13, wherein the plurality of TCP ACKs are maintained in at least one first queue, the TCP data is maintained in a second queue, and the UDP data is maintained in a third queue.

15. The computer-readable medium of claim 13, wherein each STA in the set of STAs is assigned a different queue.

16. The computer-readable medium of claim 13, further comprising code to:
allocate the UDP data in the multi-user transmission;
allocate the TCP data to a subsequent PPDU before allocating a UDP data retransmission to the subsequent PPDU; and
transmit, to the set of STAs, the subsequent multi-user transmission including at least the TCP data.
